(19) United States
(12) Patent Application Publication
(10) Pub. No.: US 2008/0261535 A1
(43) Pub. Date: Oct. 23, 2008

(54) Detection of underperforming antennas of nodes of wireless networks

(75) Inventors: Kevin Weil, Redwood City, CA (US); Wenge Ren, Sunnyvale, CA (US)

Correspondence Address: Tropos Networks, P.O. Box 641867, San Jose, CA, 95164-1867, US

(73) Assignee: Tropos Networks, Inc.

(21) Appl. No.: 11/788,875

(22) Filed: Apr. 23, 2007

(51) Int. Cl. H04B 17/00

(52) U.S. Cl. 455/67.11

(57) ABSTRACT

An apparatus and method of detecting underperforming antennas of a wireless node of a wireless network are disclosed. The method includes measuring a wireless link quality between a first antenna of the wireless node and a receiver, and measuring a wireless link quality between a second antenna of the wireless node and the receiver. A difference between the wireless link quality of the first antenna and the link quality of the second antenna is determined. The wireless node is identified as having an underperforming antenna, if the difference between the wireless link qualities between the first antenna and the second antenna is greater than a faulty antenna detection threshold.

### FIELD OF THE EMBODIMENTS

The embodiments disclosed relate generally to wireless communications. More particularly, the embodiments disclosed relate to a method and apparatus for detecting underperforming antennas of nodes of wireless networks.

### BACKGROUND

Wireless mesh networks are gaining popularity because wireless infrastructures are typically easier and less expensive to deploy than wired networks. The wireless mesh networks typically include wired gateways that are wirelessly connected to wireless nodes, or wirelessly connected directly to client devices. Many wireless nodes can collectively provide a wireless mesh, in which client devices can associate with any of the wireless nodes.

Routing paths can be selected between the nodes of the mesh network according to one or more of many possible routing selection procedures. The routing paths provide a path for data flow between a client device associated with the wireless mesh network and a gateway of the mesh network. The gateway can be wire-connected to a wired network which is connected, for example, to the internet. Due to the possibility of changing locations of the wireless nodes, and due to the typically changing link qualities of wireless connections, the best quality routing path available can vary with time.

Due to the unreliable nature of wireless links, and for the sake of redundancy, the nodes of a wireless mesh network can each include multiple antennas. If one of the antennas fails, the other antenna can be used to complete a wireless connection to another wireless mesh network node. Additionally, the second antenna provides an optionally better wireless link with a neighboring node when a node is subject to multi-path and fading.

It is desirable to have a wireless network that can identify underperforming or faulty antennas within the wireless network.

### SUMMARY

An embodiment includes a method of detecting underperforming antennas of a wireless node of a wireless network. The method includes measuring a wireless link quality between a first antenna of the wireless node and a receiver, and measuring a wireless link quality between a second antenna of the wireless node and the receiver. A difference between the wireless link quality of the first antenna and the link quality of the second antenna is determined. The wireless node is identified as having an underperforming antenna, if the difference between the wireless link qualities between the first antenna and the second antenna is greater than a faulty antenna detection threshold.

Another embodiment includes a method of detecting underperforming antennas of a wireless node of a wireless network. The method includes the wireless node selecting one of a plurality of antennas for receiving transmission signals. The wireless node counts a number of packets received by each selected antenna over a period of time. The wireless node is identified as having an underperforming antenna if the counted number of packets between the plurality of antennas is disproportionately lower for one or more of the plurality of antennas than other of the plurality of antennas.

Other aspects and advantages of the disclosed embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an example of a multiple antenna transceiver wirelessly communicating with a second transceiver.

FIG. 2 shows an example of a wireless mesh network that includes access nodes, in which at least some of the nodes include multiple antennas.

FIG. 3 is a flow chart that includes steps of an example of a method of detecting underperforming antennas of a wireless node of a wireless network.

FIG. 4 is a flow chart that includes steps of another example of a method of detecting underperforming antennas of a wireless node of a wireless network.

FIG. 5 is a flow chart that includes steps of an example of a method of detecting underperforming antennas of a wireless node of a wireless mesh network.

### DETAILED DESCRIPTION

As shown in the drawings for purposes of illustration, embodiments disclosed include an apparatus and method for identifying poor performing or faulty antennas within a wireless network. Once identified, a network operator can by notified. Additionally or alternatively, the wireless network can adaptively avoid wireless links that includes the poor performing or faulty antennas.

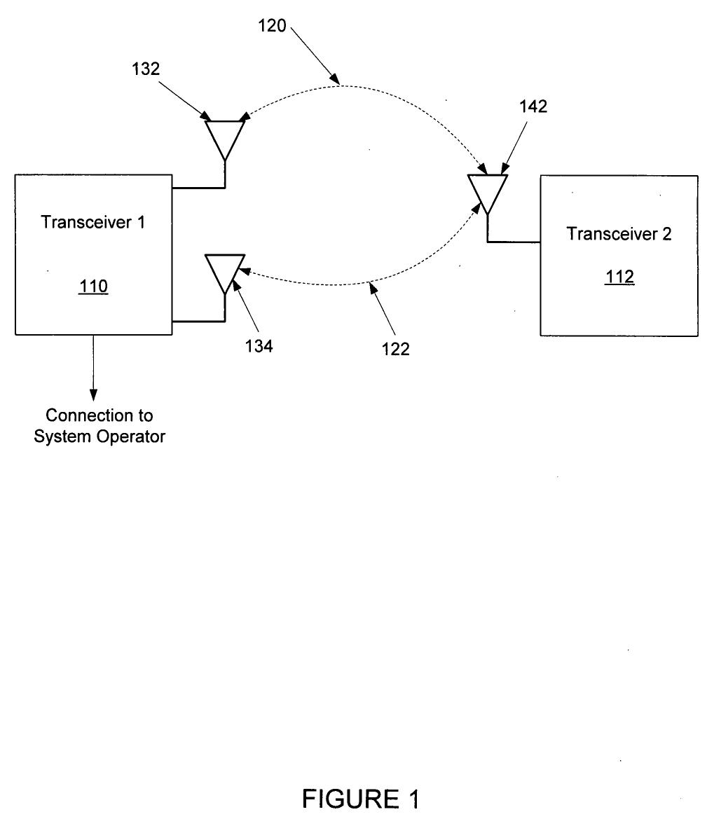

FIG. 1 shows an example of a multiple antenna (first) transceiver 110 wirelessly communicating with a second transceiver 112. The multiple antenna (first) transceiver 110 is shown with two antennas (132, 134), but it is to be understood that the multiple antenna transceiver 110 can include any number of antennas. The second transceiver 112 is shown with only a single antenna 142, but it is to be understood that the second transceiver 112 can include any number of antennas.

The formation of the wireless link (as will be described, this can actually be more than one link) between the first transceiver 110 and the second transceiver 112 can include either transmit antenna or receive antenna diversity. That is, the transmission link from the first transceiver 110 to the second transceiver 112 can utilize either one of the two transmit antennas 132, 134 depending on which one of the two transmit antennas provides the best quality transmission link. That is, a first wireless link 120 can be formed between the first transceiver 110 and the second transceiver 112, or a second wireless link 122 can be formed between the first transceiver 110 and the second transceiver. The transmit antenna 132, 134 selected depends upon the quality of the corresponding links 120, 122. More specifically, the antenna that provides the best quality wireless link is typically selected. Over time, wireless transmission impediments such as multi-path and fading can vary depending upon the environment surrounding the transceivers 110, 112 and movement of the transceivers 110, 112 relative to each other. Therefore, the antenna that provides the best quality link can change with time.

Though the methods described may select an antenna while the antennas are transmitting signals, it is to be understood that the antenna selection can also happen while the antennas are receiving signals. The selection either way is probably the same, but could be different.

The additional antenna can aid in improvement of the link quality because of the additional link selection provided by the additional wireless link. The additional antenna also provides redundancy that allows a transceiver to remain at least partially operational if one of the antennas is faulty or performing poorly. That is, if one antenna is bad, the wireless transceiver can still communicate with its good antenna. However, if one of the antennas is bad, it is desirable to alert a network operator, so that the network operator can replace or fix the faulty or poor performing antenna. Another embodiment includes the wireless network preferentially avoiding links that include a faulty or poor performing antenna.

One example of a method for identifying an underperforming antenna includes measuring or characterizing the difference in wireless link quality provided by each of the antennas of the transceiver. The wireless links typically vary some due to multi-path and fading, but a faulty antenna typically provides a link have a quality that is substantially worse than a properly operating antenna. Therefore, by comparing the link qualities provided by side by side antennas of a transceiver, an identification of a potentially faulty antenna can be made. If both (for a two antenna transceiver) of the antennas provide poor quality links, then it can be assumed that the link quality is independent of the antennas. Alternatively, it can be assumed that both antennas are bad, and the wireless link should be avoided.

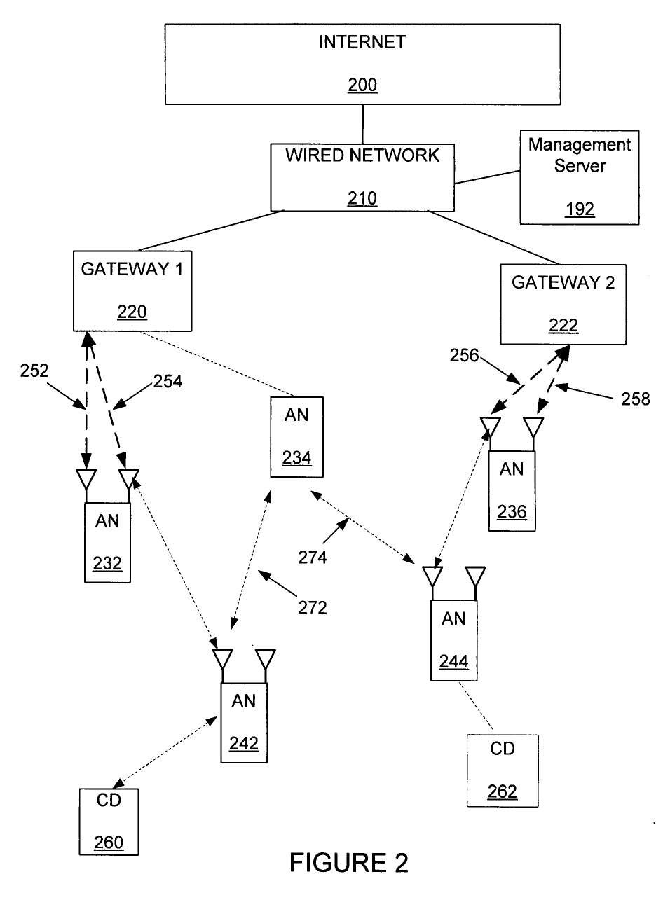

FIG. 2 shows an example of a wireless mesh network that includes access nodes, in which at least some of the nodes include multiple antennas. The principles of identifying faulty or poor performing antennas can be extended to wireless mesh networks as well. In addition to alerting a network operator of faulty antennas, the identification of faulty antennas can be used to influence routing selections through the wireless mesh network. More specifically, routing selections can avoid nodes that have a faulty antenna, or at least preferentially select upstream nodes that do not have a faulty antenna.

The wireless mesh network includes gateways 220, 222 that are wire or wirelessly connected to a wire network 210. The wired network 210 can be connected, for example, to the internet 200.

The wireless mesh network additionally includes first order (one wireless hop away from a gateway) access nodes 230, 232, 234, and second order access nodes 240, 242 (two wireless hops away from a gateway). Client devices, such as, client devices 260, 262 can wirelessly connect to any of the gateways or access nodes of the wireless mesh network, thereby obtaining a wireless connection to the internet 200. It is to be understood that the wireless mesh network can include any number of gateways and access nodes, and the order (number of wireless hops away from a gateway) is not limited.

Within the wireless mesh network, it is useful to identify access nodes that include at least one faulty or poorly operating antenna. Once identified, a network operator can be alerted of the nodes that include these antennas. An embodiment includes passively alerting the network operator if lower threshold in link quality differences is detected between antennas, and actively alerting the network operator if a higher threshold in link quality difference is detected. Passively alerting can include logging the condition, so that the network operator has access to the condition. Actively alerting can include sending an email, or visually triggering an indicator on a display that is observable by the network operator.

Another embodiment includes integrating the difference between link qualities of the antennas. If the integrated difference is determined to be larger than a first threshold, then the network operator is alerted (passively or actively). If the integrated difference is greater than a second threshold, then the network operator is again alerted (probably actively). The result being that nodes having very different link qualities per antenna alert the network operator more quickly than nodes have link qualities that are less different.

Various other methods can be used for alerting the network operators. Passively alerting the network operator can include monitoring and logging the link quality differentials of all of the nodes at, for example, the management server 192. This can include indicators of when the link quality differences have exceeded the predetermined thresholds. The differences can be continually displayed on a map representing a wireless mesh network. When the predetermined thresholds are exceeded, this can be visually depicted, for example, by changing the colors depicted on the display.

For wireless mesh network that include a large number of nodes having multiple antennas, the thresholds can be statistically determined based upon the link qualities and the variations of the link qualities throughout the wireless mesh network.

For an embodiment, the access nodes of the wireless mesh network select routing paths based at least in part, on routing beacons that originate at the gateways. The routing selection metrics can include, but are not limited to, routing beacons persistence, reverse link routing beacon persistence and hop count. The routing metrics can additionally include information regarding nodes that have been identified as having a poor performing or faulty antenna. Identified nodes can be avoided, or are preferentially not selected within a routing path.

The gateways 220, 222 broadcast routing packets (beacons), which can be used to determine select routing paths between access nodes 230-244 and gateways 220, 222 of the network. The routing beacons are broadcast at a predetermined rate (for example, a number of beacons per second). Therefore, nodes that receive the routing beacons can estimate the quality of the links to different gateways based on the persistence of successfully received routing beacons. The beacons are received by all first-level access nodes (for example, access nodes 232, 234, 236), which are access nodes that are able to receive gateway transmitted beacons, and directly route data through to a gateway.

The beacons are used to establish a route from each access node to a gateway. The first level access nodes re-broadcast the beacon data, attaching their own information to the beacon. The information indicates to the second level access nodes that the path to the gateway includes the first level access node. The nodes rebroadcast routing beacons at the rate in which they are successfully received. Therefore, downstream nodes that receive the rebroadcast beacons can estimate the quality of a routing path through the re-broadcasting nodes to a gateway. As described, information of the detection of a poor performing or faulty antenna of the first level access nodes can included within the rebroadcast routing beacons, allowing downstream access nodes include this information in their routing selection decisions.

For one embodiment, the link quality of the beacon received determines whether that beacon is rebroadcast by the system. If the quality of the beacon is above a determined threshold, it is rebroadcast. The beacons can be used to determine the quality of the link in both an upstream (towards a gateway) direction, and in a downstream (away from a gateway) direction. The upstream and the downstream link qualities can be used by each access node to select the best data routing path to a gateway.

The first level access nodes 232, 234, 236 include upstream links, and downstream links to the gateways 220, 222. The quality of a downstream link can be different than the quality of the corresponding upstream link. Link asymmetries can arise because of differences in transmit power levels at each end of the link, or due to environmental effects or signal interference.

The asymmetrical characteristics of the links between access nodes and the gateways can lead to non-optimal routing selections if, for example, the quality of the upstream links is not included in routing decisions by access nodes to gateways. Each gateway and access node transmits beacons. All access nodes and gateways that receive the beacons can make an estimate of the quality of the link based upon the reception of the beacons. The estimates can include both upstream link quality and downstream link quality. Once each access node has the upstream and downstream link qualities within every possible data path to a gateway, the access node can make a selection of the best available data path.

Each access node has at least one upstream node, and may have a plurality of downstream nodes. Upstream nodes are the nodes that are between the access node and the gateway. For a level one access node, there is at least one upstream node, the gateway. For a level four access node, there are at least four upstream nodes, which define the access node's path to the gateway. Downstream nodes are nodes that receive the beacon from a particular access node, and define their path to the gateway through that access node.

FIG. 2 also includes second level access nodes 242, 244. The second level access nodes 242, 244 receive routing beacons from first level access nodes. The second level access nodes select routing paths through first-level access nodes based at least to some extent, based on the routing beacons rebroadcast by the first-level access nodes. The routing selection metrics can be similar to the routing selection metrics of the first-order access nodes. More specifically, the routing selection metrics can include, but are not limited to, routing beacons persistence, reverse link routing beacon persistence and hop count. The routing metrics can additionally include information regarding nodes that include poor performing or faulty nodes, wherein these nodes are avoided, or preferentially not selected within a routing path.

As previously described, nodes having a faulty or poor performing antenna can be identified within the wireless mesh network by detecting link quality variation between multiple antennas of the node. For example, access nodes 232, 236 may detect themselves to have a faulty or poor performing antenna. That is, for example, a link 252 between the gateway 220 and a first antenna of the access node 232 may be detected to be substantially better or worse than a second link 254 between the gateway 220 and a second antenna of the access node 232. The antenna (first or second) associated with the link that is substantially worse than the other, can be assumed to be faulty or poor performing. A network operator can be alerted of the existence of the underperforming antenna. Additionally, the access node 232 can include within its rebroadcast routing beacons information indicating that the access node 232 has an underperforming antenna. Based on this additional information, the downstream access node 242 may select a new route to the upstream gateway 220. For example, the access node 242 may select a link 272 to upstream access node 234. Similarly, if the access node 236 detects a link quality difference between links 256, 258, an therefore, the presence of an underperforming antenna, the downstream access node 244 may select a different routing path based on information regarding the underperforming antenna of the access node 236. More specifically, the access node 244 may select the access node 234 through link 274 as its upstream access node in a routing path to the gateway 220.

For another embodiment, other link quality factors, such as traffic congestion, battery status of upstream access nodes, thickness of the pipeline, backend (i.e. gateway) capacity, latency, or other factors may be used to determine whether the beacon should be rebroadcast.

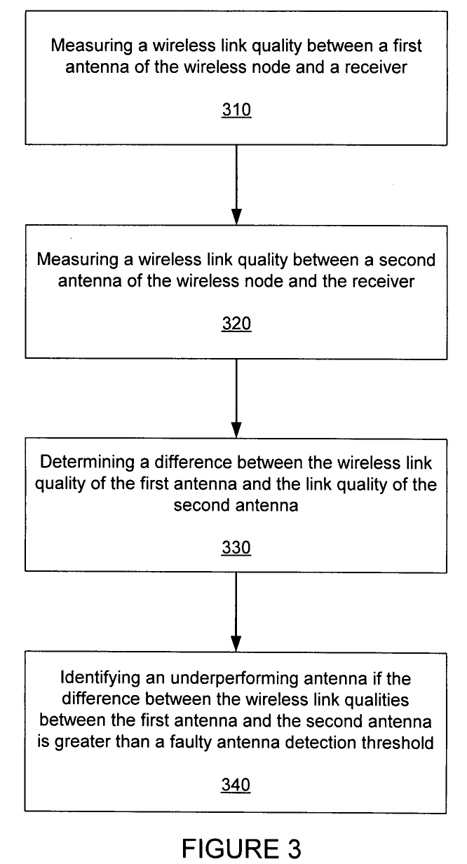

FIG. 3 is a flow chart that includes steps of an example of a method of detecting underperforming antennas of a wireless node of a wireless network. A first step 310 of the method includes measuring a wireless link quality between a first antenna of the wireless node and a receiver. A second step 320 includes measuring a wireless link quality between a second antenna of the wireless node and the receiver. A third step 330 includes determining a difference between the wireless link quality of the first antenna and the link quality of the second antenna. A fourth step 340 includes identifying an underperforming antenna if the difference between the wireless link qualities between the first antenna and the second antenna is greater than a faulty antenna detection threshold.

If an underperforming antenna is identified, an embodiment includes alerting a wireless network operator of the underperforming antenna. As described, various methods can be used for alerting the network operator.

An embodiment additionally includes the wireless node selecting one of a plurality of antennas for receiving transmission signals. The wireless node counts a number of packets received by each selected antenna over a period of time. An underperforming antenna is identified if the counted number of packets between the plurality of antennas is disproportionately lower for one or more of the plurality of antennas than other of the plurality of antennas. That is, a low packet count can provide an indication of an underperforming antenna.

Another embodiment additionally includes the wireless node selecting one of a plurality of antennas for receiving transmission signals. The wireless node monitors a percentage of time each antenna is selected for receiving signals. An underperforming antenna is identified if an antenna selection distribution between the plurality of antennas is disproportionately weighted away from one or more of the plurality of antennas.

Another embodiment additionally includes the wireless node selecting one of a plurality of antennas for receiving transmission signals. The selection includes measuring a receive signal quality for each of the plurality of antennas, and selecting the one of the plurality of antennas that provides the best receive signal quality. One embodiment of selecting the one of the plurality of antennas that provides the best receive signal quality includes receiving routing packets from an upstream access node through each of the plurality of antennas, and selecting the one of the plurality of antennas that successfully receives the routing packets with a highest level of persistence.

Selecting the one of the plurality of antennas that provides the best receive signal can additionally include receiving routing packets from an upstream access node through each of the plurality of antennas, wherein the routing packets provide reverse link quality information. The reverse link quality is the quality of the link in the upstream (towards a gateway) direction. The one of the plurality of antennas that corresponds with a highest reverse link quality is selected. The reverse link quality can be determined by measuring a persistence of successfully received reverse routing beacon. Alternatively, the reverse link quality is determined by measuring an SNR of the reverse link signals. Other signal quality parameters can be used to characterize the reverse link signals, such as, PER, BER.

An alternate or additional method of determining which of the plurality of antennas that provides the best receive signal quality includes receiving packets from an upstream access node through each of the plurality of antennas, and selecting the one of the plurality of antennas that has a highest count of received packets. Another embodiment includes receiving transmission signals from an upstream access node through each of the plurality of antennas, and selecting the one of the plurality of antennas that receives signals having a highest SNR.

As previously described, the methods of detecting underperforming antennas can be utilized for identifying underperforming antennas of wireless access nodes within a wireless mesh network. More specifically, uplinks associated with each of the access node antenna can be compared to identify underperforming antennas. For an embodiment, the receiver during the characterizing of the uplinks is an upstream node that the wireless node communicates a heaviest amount of traffic.

One embodiment of a closed loop antenna characterization includes the receiver (upstream access node or gateway) measuring the link qualities corresponding with the first antenna and the second antenna and communicating the link qualities to the wireless node. That is, the upstream node directly feedback back the antenna characterization back to the wireless access node.

Another embodiment of an open loop antenna characterization includes the wireless node measuring the link qualities corresponding with the first antenna and the second antenna by uni-casting packets and counting the acknowledgement rate of each of first antenna and the second antenna. The acknowledgement rate can provide an indication of the qualities of the uplinks of each of the antennas. Here, the upstream node does not feed the link characterizations corresponding to each of the antennas back to the wireless access node.

Various methods can be used for alerting a wireless network operator of an underperforming antenna. One method includes proactively alerting the network operator. Another method includes storing information reflecting the underperforming antenna which is accessible be the network operator.

A value the faulty antenna detection threshold can be determined based on a statistical analysis of a plurality of wireless links over time. That is, the quality of several of the wireless links can be monitored over time. A mean or average value of the link quality can be calculated. The faulty antenna detection threshold can be set to any number of standard deviations from the mean value of the link quality.

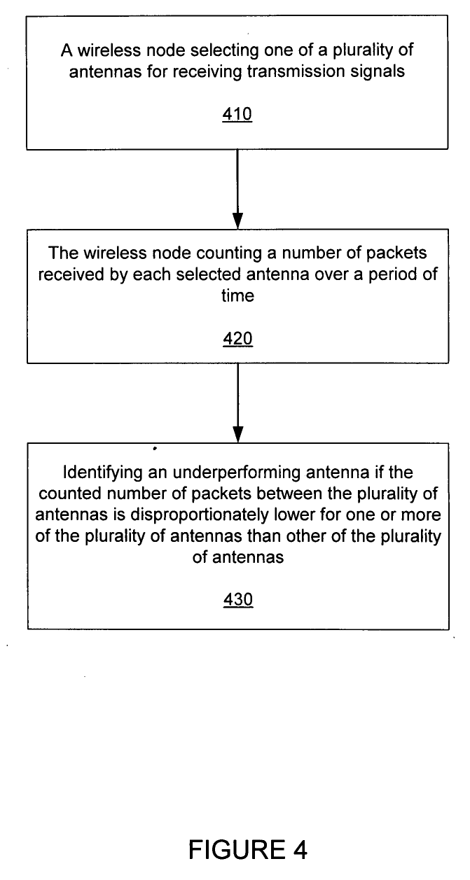

FIG. 4 is a flow chart that includes steps of another example of a method of detecting underperforming antennas of a wireless node of a wireless network. A first step 410 of the method includes the wireless node selecting one of a plurality of antennas for receiving transmission signals. A second step 420 includes the wireless node counting a number of packets received by each selected antenna over a period of time. A third step 430 includes identifying an underperforming antenna if the counted number of packets between the plurality of antennas is disproportionately lower for one or more of the plurality of antennas than other of the plurality of antennas.

As previously described, if an underperforming antenna is identified, an embodiment includes alerting a wireless network operator of the underperforming antenna. As described, various methods can be used for alerting the network operator.

As previously described, the selected antenna is generally the antenna that provides the best quality wireless link to the upstream node (access node or gateway). As previously described, various different methods (including a highest persistence of successfully received routing packets) can be used to determine the link quality. If the link associated with a particular antenna is rarely, or never selected, it can be assumed the particular antenna is underperforming. Therefore, counting the number of packets received by each antenna over a period of time provides an indication of the disparity in link quality for each of the antennas, allowing underperforming antennas to be identified.

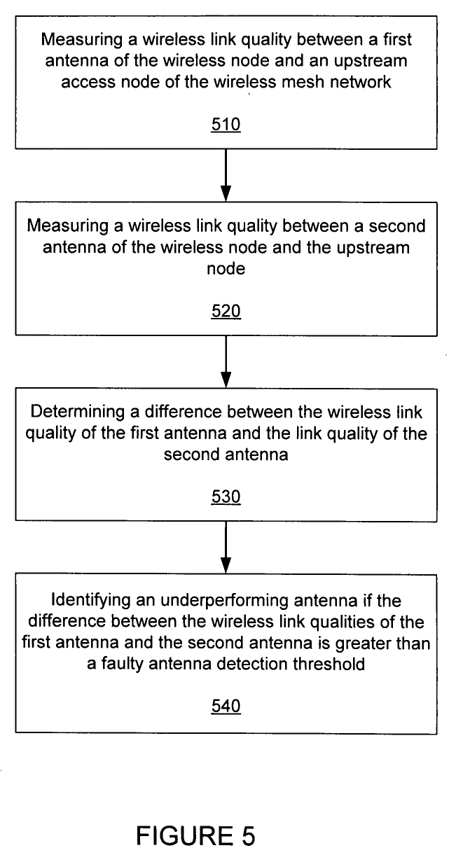

FIG. 5 is a flow chart that includes steps of an example of a method of detecting underperforming antennas of a wireless node of a wireless mesh network. A first step 510 includes measuring a wireless link quality between a first antenna of the wireless node and an upstream access node of the wireless mesh network. A second step 520 includes measuring a wireless link quality between a second antenna of the wireless node and the upstream node. A third step 530 includes determining a difference between the wireless link quality of the first antenna and the link quality of the second antenna. A fourth step 540 includes identifying an underperforming antenna if the difference between the wireless link qualities of the first antenna and the second antenna is greater than a faulty antenna detection threshold.

As previously described, a wireless mesh network operator of wireless mesh network can be alerted of the underperforming antenna, allowing the network operator to fix the underperforming antenna.

An embodiment of the wireless mesh network includes determining a difference between wireless link qualities between multiple antennas of each of a plurality of access nodes within the wireless mesh network. The faulty antenna detection threshold can be adaptively determined based on statistical analysis of the differences of each of the plurality of access nodes. For one embodiment, this includes monitoring the differences between wireless link qualities between multiple antennas of each of a plurality of access nodes within the wireless mesh network over time, and adaptively determining the faulty antenna detection threshold based on statistical analysis of the differences of each of the plurality of access nodes over time.

Although specific embodiments have been described and illustrated, the embodiments are not to be limited to the specific forms or arrangements of parts so described and illustrated. The embodiments are limited only by the appended claims.

What is claimed:

1. A method of detecting underperforming antennas of a wireless node of a wireless network, comprising:
measuring a wireless link quality between a first antenna of the wireless node and a receiver;
measuring a wireless link quality between a second antenna of the wireless node and the receiver;
determining a difference between the wireless link quality of the first antenna and the wireless link quality of the second antenna; and
identifying an underperforming antenna if the difference between the wireless link qualities between the first antenna and the second antenna is greater than a faulty antenna detection threshold.

2. The method of claim 1, further comprising alerting a wireless network operator of the underperforming antenna.

3. The method of claim 2, wherein the difference between the link qualities is integrated over time, and the network operator is passively alerted if the integrated difference exceeds a first threshold, and actively alerted if the integrated difference exceeds a second threshold.

4. The method of claim 1, further comprising:
the wireless node selecting one of a plurality of antennas for receiving transmission signals;
the wireless node counting a number of packets received by each selected antenna over a period of time;
identifying the underperforming antenna if the counted number of packets between the plurality of antennas is disproportionately lower for one or more of the plurality of antennas than other of the plurality of antennas.

5. The method of claim 1, further comprising:
the wireless node selecting one of a plurality of antennas for receiving transmission signals;
the wireless node monitoring a percentage of time each antenna is selected for receiving signals;
identifying the underperforming antenna if an antenna selection distribution between the plurality of antennas is disproportionately weighted away from one or more of the plurality of antennas.

6. The method of claim 1, further comprising the wireless node selecting one of a plurality of antennas for receiving transmission signals, comprising:
measuring a receive signal quality for each of the plurality of antennas;
selecting the one of the plurality of antennas that provides the best receive signal quality.

7. The method of claim 6, wherein selecting the one of the plurality of antennas that provides the best receive signal quality comprises:
receiving routing packets from an upstream access node through each of the plurality of antennas;
selecting the one of the plurality of antennas that successfully receives the routing packets with a highest level of persistence.

8. The method of claim 6, wherein selecting the one of the plurality of antennas that provides the best receive signal quality comprises:
receiving routing packets from an upstream access node through each of the plurality of antennas, wherein the routing packets provide reverse link quality information;
selecting the one of the plurality of antennas that corresponds with a highest reverse link quality.

9. The method of claim 8, wherein the reverse link quality is determined by measuring a persistence of successfully received reverse routing beacon persistence.

10. The method of claim 8, wherein the reverse link quality is determined by measuring an SNR or reverse link signals.

11. The method of claim 6, wherein selecting the one of the plurality of antennas that provides the best receive signal quality comprises:
receiving packets from an upstream access node through each of the plurality of antennas;
selecting the one of the plurality of antennas that has a highest count of received packets.

12. The method of claim 6, wherein selecting the one of the plurality of antennas that provides the best receive signal quality comprises:
receiving transmission signals from an upstream access node through each of the plurality of antennas;
selecting the one of the plurality of antennas that receives signals having a highest SNR.

13. The method of claim 1, further comprising the wireless node being within a wireless mesh network, and the receiver is an upstream node that the wireless node communicates a heaviest amount of traffic.

14. The method of claim 1, further comprising the receiver measuring the link qualities corresponding with the first antenna and the second antenna and communicating the link qualities to the wireless node.

15. The method of claim 1, further comprising the wireless node measuring the link qualities corresponding with the first antenna and the second antenna by uni-casting packets and counting the acknowledgement rate of each of first antenna and the second antenna.

16. The method of claim 1, wherein alerting a wireless network operator of an underperforming antenna comprises storing information reflecting the underperforming antenna.

17. The method of claim 1, wherein a value of the faulty antenna detection threshold is determined based on a statistical analysis of a plurality of wireless links over time.

18. A method of detecting underperforming antennas of a wireless node of a wireless network, comprising:
the wireless node selecting one of a plurality of antennas for receiving transmission signals;
the wireless node counting a number of packets received by each selected antenna over a period of time;
identifying an underperforming antenna if the counted number of packets between the plurality of antennas is disproportionately lower for one or more of the plurality of antennas than other of the plurality of antennas.

19. The method of claim 18, further comprising alerting a wireless network operator of the identified underperforming antenna.

20. The method of claim 18, further comprising:
measuring a wireless link quality between a first antenna of the wireless node and a receiver;
measuring a wireless link quality between a second antenna of the wireless node and the receiver;
determining a difference between the wireless link quality of the first antenna and the link quality of the second antenna; and
alerting the wireless network operator of an underperforming antenna if the difference between the wireless link qualities between the first antenna and the second antenna is greater than a faulty antenna detection threshold.

21. A method of detecting underperforming antennas of a wireless node of a wireless mesh network, comprising:
measuring a wireless link quality between a first antenna of the wireless node and an upstream access node of the wireless mesh network;
measuring a wireless link quality between a second antenna of the wireless node and the upstream node;
determining a difference between the wireless link quality of the first antenna and the link quality of the second antenna; and
identifying an underperforming antenna if the difference between the wireless link qualities of the first antenna and the second antenna is greater than a faulty antenna detection threshold.

22. The method of claim 21, further comprising alerting a wireless mesh network operator of the identified underperforming antenna.

23. The method of claim 21, further comprising:
the wireless node selecting one of a plurality of antennas for receiving transmission signals from at least one upstream access node;
the wireless node a number of packets received by each selected antenna over a period of time;
identifying an underperforming antenna if the counted number of packets between the plurality of antennas is disproportionately lower for one or more of the plurality of antennas than other of the plurality of antennas.

24. The method of claim 23, further comprising:
the wireless node selecting a routing path to a gateway of the wireless mesh network, wherein the selection is based at least in part on whether the difference between the wireless link qualities between the first antenna and the second antenna is greater than a faulty antenna detection threshold.

25. The method of claim 23, further comprising:
the wireless node selecting a routing path to a gateway of the wireless mesh network, wherein the selection is based at least in part on whether the counted number of packets between the plurality of antennas is disproportionately lower for one or more of the plurality of antennas than other of the plurality of antennas.

26. The method of claim 25, wherein the selection is additionally based at least in part on a persistence of successfully received routing packet, a persistence of successfully received reverse routing packets.

27. The method of claim 25, wherein the selection is additionally based at least in part on a persistence of successfully received routing packet, a persistence of successfully received reverse routing packets.

28. The method of claim 21, further comprising:
determining a difference between wireless link qualities between multiple antennas of each of a plurality of access nodes within the wireless mesh network; and
adaptively determining the faulty antenna detection threshold based on statistical analysis of the differences of each of the plurality of access nodes.

29. The method of claim 27, further comprising:
monitoring the differences between wireless link qualities between multiple antennas of each of a plurality of access nodes within the wireless mesh network over time;
adaptively determining the faulty antenna detection threshold based on statistical analysis of the differences of each of the plurality of access nodes over time.
